(19) United States
(12) Patent Application Publication
(10) Pub. No.: US 2026/0333057 A1
(43) Pub. Date: Oct. 22, 2026

(54) METHOD OF REDUCING OR ELIMINATING INTERFERENCE BETWEEN TWO MUTUALLY NOT INTEROPERABLE COMMUNICATION SYSTEMS ACCESSING AN AT LEAST PARTLY SHARED RESOURCE

(71) Applicants: Continental Automotive Technologies GmbH, Hannover (DE); NANYANG TECHNOLOGICAL UNIVERSITY, Singapore (SG)

(72) Inventors: David GONZÁLEZ GONZÁLEZ, Hannover (DE); Rakshith JAGANNATH, Singapore (SG); Yong Liang GUAN, Singapore (SG); Rikin SHAH, Hannover (DE)

(73) Assignees: Continental Automotive Technologies GmbH, Hannover (DE); NANYANG TECHNOLOGICAL UNIVERSITY, Singapore (SG)

(21) Appl. No.: 19/115,584

(22) PCT Filed: Sep. 25, 2023
(86) PCT No.: PCT/IB2023/059446

§ 371 Date: Mar. 26, 2025

(30) Foreign Application Priority Data
Sep. 27, 2022 (SG) 10202251181E

(51) Int. Cl. H04W 16/14; H04W 72/0446; H04W 92/18

(52) U.S. Cl. CPC H04W 16/14; H04W 72/0446; H04W 92/18

(57) ABSTRACT

A method of coordinating access of first-type apparatus comprising a first-type wireless interface and second-type apparatus including a second-type wireless interface, to a shared resource through operation of a third type apparatus including both types of wireless interface that are communicatively coupled to each other is presented, parts or portions of which radio resource being at least partly and/or temporarily used shared between the first-type and second-type apparatus. The first-type and second-type wireless communication interfaces are mutually not interoperable. The method proposes, in the third type apparatus, distributing information about time offsets between the start of a transmission and/or a transmission frame in accordance with the first communication standard in a first subframe of a shared resource pool and the start of a transmission and/or a transmission frame in accordance with the second communication standard in the first subframe of the shared resource pool of the shared resource.

### CROSS REFERENCE TO RELATED APPLICATIONS

This application is the U.S. National Phase application of PCT International Application No. PCT/IB2023/059446, filed Sep. 25, 2023, which claims priority to Singapore Patent Application Ser. No. 10202251181E, filed Sep. 27, 2022, the contents of such applications being incorporated by reference herein.

### FIELD OF THE INVENTION

The present invention relates to wireless communication, more specifically to the reduction or elimination of interference through coordination of the use of an at least partly shared resource pool.

### BACKGROUND OF THE INVENTION

In today's connected world many devices are connected to other devices or systems through wireless connections. Such devices may include portable or mobile devices, sensors, and even motor vehicles. Several communication standards have been developed, deployed, and retired, in the past, all of which use a respective portion of the wireless spectrum for transmitting. Some older wireless communication standards include GSM (global system for mobile communication), also referred to as 2G, and UMTS (universal mobile telecommunication system), also referred to as 3G. While not fully retired, their data rates and capability to simultaneously serve a large number of users do not live up to the requirements of the ever increasing number of connected mobile devices, which led to the development and deployment of LTE (long term evolution), or 4G, and later NR (new radio), also referred to as 5G.

One important use case for both LTE and NR communication systems is found in intelligent transportation systems (ITS), which increasingly implement vehicle-to-vehicle (V2V), vehicle-to-infrastructure (V2I) and other communication between vehicles and radio-enabled objects or services in relative proximity of the vehicle.

The acronym V2X, for vehicle-to-everything (or anything, for that matter) is meant to cover all conceivable communication scenarios.

In V2X communication the data transfer is preferably done directly between the communication partners, without using a base station or other elements of the network as intermediary, since direct communication exhibits lower delay between transmission and reception. As such direct communication may use the same communication interface as the LTE or NR communication that goes to and trough the corresponding network, but the data is not routed to the base station and through the network, the direct communication is also referred to as ‘sidelink’ communication, or SL.

LTE V2X is expected to operate on the 5.9 GHz band reserved in certain markets, e.g., United States, Europe, China, for ITS services. For SL communications, vehicles, wireless apparatus, or user equipment (UE), as used interchangeably herein, utilize the so-called PC5 interface, whereas they utilize the Uu interface for vehicle-to-network (V2N) communication. LTE V2X has been designed to support basic cooperative active traffic safety, traffic management, and telematics applications and services. LTE V2X supports similar services as those supported by DSRC or its European counterpart ITS-G5. These applications and services rely on the broadcast transmission of small awareness messages such as cooperative awareness messages (CAM) in ITS-G5 or basic safety messages (BSM) in DSRC to regularly provide basic information such as the location, direction, speed, and acceleration of the transmitting vehicle. LTE V2X defines new physical (PHY) and medium access control (MAC) layers for V2X and reuses the upper V2X layers and protocols specified by ETSI (European Telecommunications Standardization Institute), IEEE (Institute of Electrical and Electronic Engineers), and SAE (Society of Automotive Engineers).

LTE V2X defines two resource allocation modes, mode 3 and mode 4, for V2X SL communications. In mode 3, the cellular or network infrastructure (eNB) manages the V2X SL communications. This includes selecting and configuring the communication resources, i.e., sub-channels. In contrast, mode 4 can operate without cellular infrastructure support. In this case, vehicles autonomously select, manage and configure the sub-channels. Vehicles utilizing mode 3 need to be under network coverage, while vehicles using mode 4 can operate without network coverage.

LTE V2X uses SC-FDMA (Single-Carrier Frequency-Division Multiple Access) and supports 10 MHz and 20 MHz channels. The channel is divided into 180 KHz Resource Blocks (RBs) that correspond to 12 subcarriers of 15 kHz each. In the time domain, the channel is organized into 1 ms subframes. FIG. 1 illustrates the channelization in LTE V2X mode 4 sensing-based SPS scheduling with an exemplary length T=100 ms. Each subframe has 14 OFDM symbols with normal cyclic prefix. Nine of these symbols are used to transmit data and four of them (3rd, 6th, 9th, and 12th) are used to transmit demodulation reference signals (DMRSs) for channel estimation and combating the Doppler effect at high speeds. The last symbol is used as a guard symbol for timing adjustments and for allowing vehicles to switch between transmission and reception across subframes.

RBs are grouped into sub-channels. A sub-channel can include RBs only within the same subframe. The number of RBs per sub-channel can vary and is (pre-)configured. (Pre-)configuration refers to a configuration that is:
1) defined by the network and signalled to the UE by the cellular base station (eNB in LTE or gNB in 5G NR) when a UE is in network coverage; or
2) predefined in the UE when the UE is out of network coverage. Sub-channels are used to transmit data and control information. The data is organized in Transport Blocks (TBs)

The LTE standard does not specify an algorithm for the selection of sub-channels in mode 3. Instead, it defines two scheduling approaches, dynamic scheduling and Semi-Persistent Scheduling (SPS). With dynamic scheduling, UEs must request sub-channels from the eNB for each TB. With SPS scheduling, the eNB reserves sub-channels so that a UE can transmit several TBs. The eNB can configure the periodicity of the reserved sub-channels. LTE mode 3 can outperform LTE mode 4 since the scheduling of transmissions is centralized at the eNB. However, it requires operating in network coverage and introduces cellular uplink (UL) and downlink (DL) signalling overhead. LTE mode 3 can also encounter challenges at the cell boundaries, in particular when different operators serve neighbouring UEs.

Under LTE mode 4, UEs autonomously select their sub-channels using the sensing-based SPS scheduling scheme specified in 3GPP Release 14/15. A UE uses the selected sub-channels for the transmission of its following Reselection Counter consecutive TBs. The UE announces the reservation of the selected sub-channels for the transmission of the next TB using the Resource Reservation Interval (RRI) included in the sidelink control information (SCI). This is likewise illustrated in FIG. 1, where a UE selects sub-channel(s) at subframe t_{TX}, and informs neighbouring UEs that it reserves them for its following transmission at subframe t_{TX}+RRI. This is done to prevent other UEs from utilizing the same sub-channels at the same time. The RRI can be equal to 0 ms, 20 ms, 50 ms, 100 ms or any multiple of 100 ms up to a maximum value of 1000 ms. A UE sets the RRI equal to 0 ms to announce neighbouring UEs that it is not reserving the same sub-channels for the next TB. A UE can only select RRIs values higher than 0 ms from a (pre-)configured list of permitted RRI values. This list can contain up to 16 values although currently 3GPP standards only define 12 possible RRIs values higher than 0 ms for mode 4.

5G NR V2X has been designed to complement LTE V2X. While LTE V2X supports basic active safety and traffic management use cases, 5G NR V2X supports advanced use cases and higher automation levels. Like LTE, the 5G system architecture supports two operation modes for V2X communication, namely V2X communication over the PC5 reference point or interface and V2X communication over the Uu reference point or interface.

5G NR is specified for operation in two frequency ranges, FR1 extending from 450 MHz to 6 GHz and FR2 extending from 24.25 GHz to 52.6 GHZ. In NR Uu, the maximum carrier bandwidth is 200 MHz for FR1 and 400 MHz in FR2. Although the NR infrastructure (gNB) can support such wide bandwidths, this may not be the case for all UEs, in particular low-end UEs. Furthermore, supporting a very large bandwidth may also imply higher power consumption at the UE, both from the radio frequency (RF) and baseband signal processing perspectives. To support UEs that cannot handle large bandwidths, e.g., due to processing limitations or high power consumption, the concept of bandwidth part (BWP) has been introduced. A BWP consists of a contiguous portion of bandwidth within the carrier bandwidth where a single numerology is employed. By defining a small BWP, the computational complexity and power consumption of a UE can be reduced. As each BWP can have a different bandwidth and numerology, BWPs enable a more flexible and efficient use of the resources by dividing the carrier bandwidth for multiplexing transmissions with different configurations and requirements. The term numerology is commonly understood as referring to physical waveform characteristics in terms of subcarrier spacing and corresponding time domain length. In 5G NR, the subcarrier spacing can vary from 15 kHz to 960 KHz as of release 17, and there are 7 types of numerology: SCS 15, 30, 60, 120, 240, 480, 960 Khz. In contrast, in LTE there is only one numerology, which is SCS 15 kHz. Larger SCS allow for lower latency and support higher-frequency bands, while smaller SCS are suitable for lower-frequency bands and increased coverage. The symbol duration in 5G NR is inversely proportional to the SCS. A larger SCS results in a shorter symbol duration, enabling faster data transmission and lower latency.

In 5G NR V2X, a subset of the available SL resources is (pre-)configured to be used by several UEs for their SL transmissions. This subset of available SL resources is referred to as a resource pool (RP) and is illustrated in FIG. 2. A resource pool may comprise any number of neighbouring or consecutive sub channels and multiple consecutive time slots. The resource blocks within an RP are referred to as physical resource blocks (PRB). An RP consists of contiguous PRBs and contiguous or non-contiguous slots that have been (pre-)configured for SL transmissions. An RP must be defined within the SL BWP. Therefore, a single numerology is used within an RP. If a UE has an active uplink (UL) BWP, the SL BWP must use the same numerology as the UL BWP if they are both included in the same carrier. Otherwise, the SL BWP is deactivated. The term numerology is used, inter alia, for the subcarrier spacing of the PRBs and may be expressed in kHz-units.

In the frequency domain, an RP is divided into a (pre-)configured number L of contiguous sub-channels, where a sub-channel consists of a group of consecutive PRBs in a slot. The number M_{sub} of PRBs in a sub-channel corresponds to the sub-channel size, which is (pre-)configured within an RP. In NR V2X SL, the sub-channel size M_{sub} can be equal to 10, 12, 15, 20, 25, 50, 75, or 100 PRBs. A sub-channel represents the smallest unit for a sidelink data transmission or reception. A sidelink transmission can use one or multiple sub-channels. In the time domain, the slots that are part of an RP are (pre-)configured and occur with a periodicity of 10240 ms. The slots that are part of an RP can be (pre-)configured with a bitmap. The length of the bitmap can be equal to 10, 11, 12, . . . , 160.

An RP can be used for all transmission types, i.e., unicast, groupcast, and broadcast, and can be shared by several UEs for their SL transmissions. A UE can be (pre-)configured with multiple RPs for transmission, i.e., transmit RPs, and with multiple RPs for reception, i.e., receive RPs. A UE can then receive data on resource pools used for SL transmissions by other UEs, while the UE can still transmit on the SL using its transmit resource pools.

5GAA release 16 defines two modes, mode 1 and mode 2, for the selection of sub-channels in NR V2X SL communications using the NR V2X PC5 interface. These two modes are the counterparts to modes 3 and 4 in LTE V2X discussed further above. However, while NR V2X supports broadcast, groupcast, and unicast SL communications, LTE V2X only supports broadcast SL communications.

Similar to mode 3 in LTE V2X, in NR mode 1 the gNB, i.e., the network infrastructure, assigns and manages the NR SL radio resources for V2V communications using the NR Uu interface. UEs must therefore be under network coverage to operate using NR mode 1. NR SL radio resources can be allocated from licensed carriers dedicated to NR SL communications or from licensed carriers that share resources between SL and UL communications. The SL radio resources can be configured so that NR mode 1 and NR mode 2 use separate resource pools. The alternative is that NR mode 1 and NR mode 2 share the resource pool. Pool sharing can result in a more efficient use of the resources, but it is prone to potential collisions between NR mode 1 and NR mode 2 transmissions. To solve this, NR mode 1 UEs notify NR mode 2 UEs of the resources allocated for their future transmissions.

NR mode 1 uses dynamic grant (DG) scheduling like LTE V2X mode 3, but replaces the semi-persistent scheduling in LTE V2X mode 3 with a configured grant scheduling. With DG, NR mode 1 UEs must request resources to the base station for the transmission of every single TB. To this end, the UEs must send a Scheduling Request (SR) to the gNB, and the gNB responds by indicating the SL resources, i.e., the slot(s) and sub-channel(s), allocated for the transmission of a TB and up to 2 possible retransmissions of this TB. The UE informs other UEs about the resources it will use to transmit a TB and up to 2 possible retransmissions using the 1st-stage sidelink control information (SCI) messages. Nearby UEs operating under NR mode 2 can then know which resources UEs in NR mode 1 will utilize.

Like with mode 4 in LTE V2X, when using mode 2 in NR V2X UEs can autonomously select their SL resources from a resource pool, i.e., one or several sub-channels. In this case, UEs can operate without network coverage. The resource pool can be (pre-)configured by the gNB when the UE is in network coverage. NR mode 2 and LTE mode 4 differ on the scheduling scheme. LTE mode 4 operates following a sensing-based SPS scheme, while NR mode 2 can operate using a dynamic or an SPS scheme that differs from the one designed for LTE mode 4. The dynamic scheme selects new resources for each TB and can only reserve resources for the retransmissions of that TB. It is noted that in this section it is distinguished between a selected resource and a reserved resource. A reserved resource is a selected resource that a UE reserves for a future transmission by notifying neighbouring UEs using the 1 st-stage SCI messages. A UE can select and reserve resources for the transmission of several TBs and their retransmissions when utilizing the SPS scheme. It is important to note that the SPS scheme can be enabled or disabled in a resource pool by corresponding (pre-)configuration.

Large numbers of radio apparatus, or user equipment (UE), communicating either in accordance with the 4G LTE standard or the 5G NR standard may be within a common radio range and require SL communication. As LTE and NR may use identical portions of the available resources, i.e., may operate on the same frequencies or on at least partially overlapping frequency bands wireless apparatus operating in accordance with either one of the standards may try to transmit at the same time within these mutually used frequencies or frequency bands. The resulting colliding access to the same resource can only be avoided by coordinating access to the commonly used resources.

When both LTE and NR UEs are under coverage of their respective networks, reservation and access coordination to the radio resource may be achieved at the network level, i.e., the eNB and the gNB coordinate the resources that are assigned to the respective UEs. LTE and NR radio access (RA) mechanisms, however, are incompatible, even when the messages required for the RA are transmitted on the same frequency. Thus, if either LTE UEs or NR UEs are not covered by their respective network, network-coordinated access for the two incompatible communication types is not available, as the UEs not covered by their network cannot decode the resource reservation of the respective other network and will resort to the respective self-coordination modes.

It is expected that most if not all of the spectrum intended for ITS use will be allocated to LTE SL, leaving limited or no dedicated ITS spectrum to NR. One motivation to prioritize LTE SL in the ITS spectrum is related to the need to enable the basic safety V2X use cases, such as the ones described in 3GPP TS 22.885, in a relatively short term in as many vehicles as possible, for minimizing the occurrence of traffic related accidents and fatalities. As new vehicles that support both LTE SL and NR SL, and farther in the future NR SL only, continue to be introduced into the market, at some point in time there will be enough market penetration to enable the use of advanced V2X use cases, such as the ones described in 3GPP TS 22.886. However, for these advanced V2X use cases to be feasible it is required that enough spectrum is made available for NR SL both in the ITS band and in other non-ITS bands. While the latter case is being tackled by the introduction in NR SL of features such as carrier aggregation, operation in unlicensed band and beam management at FR2, the former is to be enabled via LTE SL and NR SL co-channel co-existence. Co-channel co-existence allows two different, mutually incompatible or not interoperable radio access technologies (RATs), in this case LTE-SL and NR-SL, to make use of the same radio resources. In the present context incompatible or not interoperable may include RATs in which one or both RATs have the capability of receiving and/or decoding a subset of the transmissions of the respective other RAT. A full interoperability, however, is not given.

Overlapping resource pools between two co-existing, mutually incompatible or not interoperable RATs can be avoided using a predefined, rigid resource allocation scheme. FIG. 3A schematically shows an example of a rigid resource allocation scheme. In the rigid resource allocation scheme resource pools are exclusively allocated within the resource to communication in accordance with one of the two communication standards. The light dotted background represents the commonly used resource, i.e., the channel over time, and the reservations for the different communication standards are indicated by the different hashing. Note that there may or may not be unused spaces between the different resource pool reservations, and that the respective reserved resource pools may have varying lengths and widths, i.e., numbers of contiguous sub-channels and time slots. Since the resource allocation is rigid, i.e., fixed, it can be known beforehand in all UEs that operate in accordance with a respective standard. However, while easy to implement, the rigid resource allocation cannot consider different compositions of the respective UEs within the same radio range, i.e., cannot consider cases in which more UEs that communicate in accordance with a first standard are present that those that communicate in accordance with a second standard, and cannot easily be adjusted once implemented in the UEs. Thus, resources in pools reserved for communication in accordance with one standard may go unused, while the resources for communication in accordance with the other standard are insufficient. Generally, this results in inefficiencies whenever the share of UEs of the respective communication standard within the same radio range does not correspond to the respective share in the rigid allocation.

Using unused resource elements reserved for communication in accordance with one communication standard for communication in accordance with the respective other communication standard would increase the use of the overall radio resource and thus the efficiency. However, doing so requires a mechanism to avoid or at least reduce collisions between transmissions in accordance with the two communication standards during such overlapping periods. FIG. 3 exemplarily shows partially overlapping resource pools, where some of the resources intended for communicating in accordance with one standard may be used for communication in accordance with the other standard. Here, the resources used for communication in accordance with the overlapping standard are exclusively reserved for this use. This ‘pool occupation’ will still require some coordination, and may still show inefficiencies, e.g., when the ‘occupied’ part of the pool is not fully used for communication in accordance with the occupying standard, but could have been used for communication in accordance with the other standard.

As mentioned before, not all resource elements, sub-channels and time slots are necessarily used within one resource pool provided for communication in accordance with one communication standard, and the unused resource elements are wasted. FIG. 4 depicts an exemplary LTE resource pool structure showing, inter alia, reserved or allocated resource elements and available resource elements for an adjacent resource assignment and a nonadjacent resource assignment in the physical SL control channel (PSCCH) and the physical SL shared channel (PSSCH). Adjacent and nonadjacent refers to the way the transport blocks (TB) are arranged across the subchannels. Using unused resource elements for communication in accordance with the respective other communication standard would increase the use of the overall resource and thus the efficiency.

The remaining inefficiency may be further reduced by introducing at least partially overlapping resource pools in which the overlapping part is used shared by UEs communicating in accordance with respective non-interoperable communication standards.

FIG. 5 shows a schematic example for partially overlapping resource pools in a frequency range used for co-channel co-existence, where an overlapping part or portion is used shared. As elucidated further above, this is possible without causing any problem when not all of the resource elements in the shared part or portion of the resource pools are already fully assigned for communication in accordance with one of the standards that may have priority access. This situation, i.e., the shared part not being fully assigned for use, may occur more often than not, and the methods proposed herein address situations in which a coordination of the access to the shared resource is not achieved within required parameters.

LTE has been around for a longer time than NR and is widely deployed, and its use in sidelink operation is fully evolved, stipulated and fixed, i.e., will not be modified any more. Thus, optimization of the coordination can only be achieved through corresponding implementation in the NR system.

The present invention thus assumes that LTE UE will be capable of resource reservation within a certain range of the resource pool, indicated as Class A in FIG. 5, and will not know about any possible or actual pool sharing in the overlapping part, labelled Class C. The distinction between Class A and Class C may be known to the LTE network, though. Non-legacy NR UE will know the distinction between Class B and Class C, with Class B being a range within the resource pool that may or be not be exclusive or reserved for 5G NR V2X communication. The not shared portion of Class A may be considered exclusive or reserved for 4G LTE V2X communication.

Most if not all wireless radio receivers have a gain control stage that is arranged between the antenna's output and the inputs of further electronic components for signal conditioning and/or signal decoding. The gain control stage automatically operates to adjust the received signal strength provided to the inputs of these further electronic components, such as analogue-to-digital converters (ADCs), and is commonly referred to as automatic gain control (AGC). Proper gain control ensures, inter alia, that the dynamic range of these further electronic components is optimally exploited, which results in an optimized signal-to-noise ratio (SNR) that benefits proper decoding of the received signals.

Whenever SL communications of two otherwise non-interoperable communication systems use a shared resource pool, signals from one communication system may have different signal levels than signals from the other communication system. While such differences in the signal levels may have few to no consequences in case the two non-interoperable systems operate fully synchronized, negative impacts may arise when the two non-interoperable systems are not properly synchronized, especially when the systems operate using different numerologies, i.e., use different subcarrier spacings (SCS).

As mentioned further above, a dynamic resource allocation can be implemented rather easily when UEs for either type of communication standard are within coverage of their respective network, and the coordination is achieved through the network. This setting will also allow for proper slot synchronisation and PRB assignment in each of the two non-interoperable communication systems. The situation is different when only one type of network is available, or when no network coverage is present at all.

FIG. 6 shows first exemplary arrangements of RP slots of an LTE subframe having an SCS of 15 KHz and of RP slots of NR subframes NR having an SCS of 30 KHz. The LTE subframe comprises a DATA/AGC slot which, in addition to data, carries an AGC symbol that is used for setting the receiver's AGC. The LTE subframe further comprises several DATA slots carrying data symbols, i.e., the payload, several DMRS slots, i.e., De-Modulation Reference Signals, and a GUARD slot. The various slot types are distinguished by different hashing patterns. Each NR transmission frame comprises an AGC slot and further comprises either physical sidelink shared channel (PSSCH) slots, the first two of which also comprising RBs carrying physical sidelink control channel (PSCCH) information, and DMRS slots, or comprises a slot carrying physical sidelink feedback channel (PSFCH) data. Like the LTE subframe, all NR transmission frames are terminated by a GUARD slot. Like in the LTE subframe, the various slot types are distinguished by different hashing patterns. It is noted that PSFCH is only used in transmission modes that require feedback, e.g., unicast or group cast. In NR communication systems, PSFCH data is transmitted in “even” slots, i.e., the second, or fourth, etc. slot of an NR transmission frame.

In FIG. 6 the two non-interoperable communication systems are slightly out of sync, i.e., the generally compatible slot lengths—two NR slots are exactly as long as one LTE slot—are offset against each other, indicated by the dashed lines at the extreme ends of the LTE subframe, which do not line up with the NR transmission frames. As in LTE the AGC is set after an AGC symbol for one subframe is received, typically the first symbol of each LTE subframe, and is kept constant for the entire subframe, this out-of-sync situation may result in an AGC setting that may not be adjusted for an NR signal transmitted in a neighbouring subchannel of the shared portion of the RP that has a larger SCS than LTE. Reference is made again to FIG. 4, where it is easily seen that LTE may not use all subchannels, and the unused subchannels may, thus, be used by NR. As the LTE SCS is 15 kHz and the NR SCS may be 30 kHz, an NR signal transmitted in a neighbouring subchannel may extend into the LTE subchannel, and the NR signal power is added to the LTE signal power. The LTE AGC will thus be set for the sum of the signal powers, expecting that the LTE signal level lies approximately in the middle of an acceptable or useful range. In the figure the acceptable signal level range is determined by a dynamic range of an analogue-to-digital converter (ADC) that digitises the analogue input signal for further processing, i.e., equalisation, decoding etc., and is chosen to minimise quantisation noise and prevent saturation of the ADC. However, due to the superposition of the NR signal the LTE signal lies at the lower boundary of the acceptable range, which severely impacts the ADC's operation in case the LTE signal level is reduced, e.g., by any kind of attenuation.

This situation is exemplarily shown in the lower part of FIG. 6. Here, the solid line represents the received signal level power envelope at an LTE receiver during an LTE subframe in the presence of NR transmissions in a shared portion of an RP.

The dash-dotted lines indicate a useful dynamic range of an ADC of the LTE receiver, i.e., a range in which the ADC provides a useful and sufficiently fine quantisation for input signals that may vary over time, while giving some headroom for preventing saturation of the ADC. As the NR AGC signal is transmitted while the signal used for setting the LTE AGC is received at the LTE receiver, the two power levels are added up at the LTE receiver's input and the AGC is adjusted such that the resulting total received power level lies approximately in the middle of the ADC's dynamic range.

The signal level of the LTE subframe LTE Tx, indicated by the light-dotted background, is assumed constant over the entire LTE subframe, except for the guard slot, where the LTE signal level is zero. The signal level of the first NR transmission frame NR Tx1, indicated by the dark-dotted background and assumed constant over the entire NR transmit frame, except for the guard slot, where the signal level is zero, is relatively low. The improper adjustment of the AGC due to the presence of the NR AGC signal in the critical phase results in an LTE signal level that is at the lower boundary of the ADC's useful dynamic range. Any higher LTE signal level that may occur for any reason will not immediately cause problems, but any lower LTE signal level, e.g., due to attenuation or for any other reason, will lie well below the ADC's useful dynamic range, resulting in noticeable quantisation errors that have a negative impact on the LTE receiver's performance. Other than that, the added LTE and NR signal levels at the LTE receiver will not cause any saturation of the ADC.

The situation is different for the second NR transmission frames NR Tx2 and NR Tx3. The signal level of the NR signal is again indicated by the dark-dotted background and is assumed constant over the entire NR transmit frame, except for the guard slot, where the signal level is zero. However, here the NR signal level is relatively high and when the LTE and NR signals add up at the LTE receiver they drive the power envelope well beyond the ADC's maximum dynamic range boundary, thereby saturating the ADC, even though the ADC's dynamic was initially wrongly adjusted towards a higher signal input power. The ADC's saturation is indicated by the bold diagonal hashed pattern. Saturating an ADC causes non-linear distortion which creates wideband spectral noise, severely impacting the dynamic range of the receiver and any signal decoding downstream of the ADC.

FIG. 7 shows second exemplary arrangements of RP slots of an LTE subframe having an SCS of 15 KHz and of RP slots of NR subframes NR having an SCS of 30 KHz. The LTE subframe is identical to the one shown in FIG. 6, while only NR transmission frames corresponding to the second and third NR transmission frames NR Tx2 and NR Tx3 in FIG. 6 are present. Here, the LTE AGC correctly places the LTE signal level approximately in the middle of the useful ADC dynamic range, indicated by the dash-dotted lines. The first slots of the LTE subframe will be received and decoded without problems, as there is no interfering NR signal. However, when the NR transmission frames NR Tx2 and NR Tx3 add their signal power to the LTE signal, the combined power envelope is pushed far beyond the upper limit of the ADC's useful dynamic range upper boundary, severely saturating the LTE receiver's input.

In light of the discussion above a desire remains to address at least some situations in which such interference between signals from first and second communication systems that are non-interoperable and that are transmitted in a shared resource occur.

### SUMMARY OF THE INVENTION

Thus, an aspect of the present invention aims to provide a method of reducing or eliminating interference between two mutually interoperable communication systems accessing an at least partly shared resource.

The various methods presented herein and/or their respective implementation in wireless apparatus or communication devices may operate individually or complementary to achieve an aspect of the invention.

An aspect of the present invention presented hereinafter addresses at least some of the problems discussed above by appropriately controlling access of UEs configured for communication in accordance with a second one of the two mutually not interoperable communication systems to RBs of shared resource pools in situations, in which network coverage of at least the second one of the mutually not interoperable communication systems is not provided in a given area, and in which at least one dual mode UE is present in said given area, which at least one dual mode UE comprises respective network interfaces for communicating in accordance with each one of the mutually not interoperable communication standards. Such control improves the operation of at least UEs configured for communication in accordance with a first one of the two mutually not interoperable communication systems while using the at least partly shared resource within said given area.

Prior to a detailed presentation of the invention a brief overview over exemplary scenarios addressed by the invention will be given. As initially described, both LTE and NR have operating modes in which the respective network is not available and the UEs perform autonomous resource allocation.

As mentioned earlier, the coordination of the resource allocation can either be network-controlled, i.e., the network—through the eNB or gNB—determines and assigns the resources that can be used by a UE in a centralized manner, and the UE simply uses the assigned resources, or UE-controlled. In UE-controlled resource allocation the UEs autonomously and in a distributed manner determine the resources that can be used. Bearing this in mind, RA coordination trouble may arise in scenarios in which UEs exclusively capable of communicating in accordance with the a first standard (UE-A), e.g., the 4G LTE standard, and UEs capable of communicating in accordance with a second standard (UE-B), e.g., the 5G NR standard, are located in areas that have a first standard-only or second standard-only network coverage, e.g., LTE-only or NR-only. In this case, a network-controlled resource allocation will not be known to all UEs within the area of first or second standard-only network coverage, as the resource allocation by the first standard NB is not received or understood by a second standard-only UE-B, and the resource allocation by a second standard NB is not received or understood by a first standard-only UE-A. Hence, the respective UEs that cannot benefit from the network-controlled resource allocation will resort to UE-controlled resource allocation. Since the two resource allocation schemes are not mutually coordinated, allocated resource pools may at least partially overlap, which may result in disturbed or even failed communication attempts due to signal interference. In addition, the time synchronisation between the two types of UE may not be as tight as required for successful co-existence and use of shared resources.

Coordination trouble may likewise arise in areas without any network coverage at all, when first standard-only UE-A and second standard-only UE-B each try to perform the respective UE-controlled resource allocation. Here, too, the respective UEs that communicate in accordance with respective non-interoperable standards will have no knowledge of the respective other resource allocation, which may result in at least partially overlapping allocated resource pools, and the time synchronisation may likewise be insufficient for successful co-existence and use of shared resources.

As briefly mentioned earlier, some wireless apparatus may be equipped with respective communication interfaces for communicating in accordance with the first standard and the second standard, e.g., 4G LTE and 5G NR. These apparatus may also be referred to as dual mode UEs and are designated herein as UE-C. The corresponding communication interfaces of such wireless apparatus may be communicatively coupled internally in the UE-C, i.e., and the knowledge of resource reservations received in accordance with a respective standard may be shared. However, as yet this shared knowledge remains internal and privy to the respective UE-C, if it is internally shared at all. Thus, even when one or more dual mode UEs are present in the two scenarios discussed above, a full coordination of the resource allocation between first standard-only UE-A and second standard-only UE-B is missing.

FIGS. 8A-8B show exemplary representations of the situations discussed above. In FIG. 8A only LTE network coverage is provided in an area, in which first standard-only UE-A, second standard-only UE-B and dual mode UE-C are located. In the figure the UE-A are represented by the vehicle with the circle with the vertical hashing, the UE-B are represented by the vehicle with the circle with the horizontal hashing, and the UE-C are represented by the vehicle with the circle with the cross-hashing. The LTE network, represented by the radio tower icon labelled eNB, can only allocate resources to the UE-A and the NR wireless interface of the UE-C, indicated by the arrows. The UE-B will not have knowledge of the resource allocation through the LTE eNB, indicated by the question marks, and will resort to UE-controlled resource allocation performed by the UE-B, which may cause interferences in at least partially overlapping resource pools and/or assigned resources and which may result in insufficient time synchronisation between the UE-B and the UE-A.

In FIG. 8B only NR network coverage is provided in an area, in which first standard-only UE-A, second standard-only UE-B and dual mode UE-C are located. Like in FIG. 8A the UE-A are represented by the vehicle with the circle with the vertical hashing, the UE-B are represented by the vehicle with the circle with the horizontal hashing, and the UE-C are represented by the vehicle with the circle with the cross-hashing. The NR network, represented by the radio tower icon labelled gNB, can only allocate resources to the UE-B and the NR wireless interface of the UE-C, indicated by the arrows. The UE-A will not have knowledge of the resource allocation through the NR gNB, again indicated by the question marks, and will resort to UE-controlled resource allocation performed by the UE-A, which may cause interferences in at least partially overlapping resource pools and/or assigned resources and which may result in insufficient time synchronisation between the UE-B and the UE-A.

FIG. 9 schematically shows a situation in which no network coverage is provided at all in a given area, in which first standard-only UE-A, second standard-only UE-B and dual mode UE-C are located. Like in FIGS. 8A and 8B the UE-A are represented by the vehicle with the circle with the vertical hashing, the UE-B are represented by the vehicle with the circle with the horizontal hashing, and the UE-C are represented by the vehicle with the circle with the cross-hashing. Since no network is available for coordinating radio access, both the UE-A and the UE-B independently perform UE-controlled resource allocation. It is obvious that the UE-A have no knowledge of the allocation agreed to by the UE-B and vice versa, indicated by the questions marks, and that only UE-C that happen to be in the given area can have knowledge of both allocations, indicated by the exclamation marks. In any case, that leaves one or more UEs without a full knowledge of the actual use of the shared resource, which can lead to the communication problems mentioned above.

It is reminded that it is assumed that LTE takes priority over NR in terms of resource allocation and synchronisation, since the standard is set and may not be modified for adapting to the situations described above. Further, sidelink operation, especially in out-of-coverage situations, allows using different synchronization sources, including other UE as sync. reference, which increases the likelihood of insufficient synchronisation between the two mutually not interoperable communication systems accessing the shared resource.

While solutions for addressing the resource allocation in the situations described above are known, e.g., using the method presented in PCT/IB2023/057907, timing offsets are not addressed and can still disturb the communication in the shared resource.

Thus, in accordance with a first aspect of the invention a method of operating a third-type apparatus comprising a first-type wireless interface configured for communication in accordance with a first communication standard and a second-type wireless interface configured for communication in accordance with a second communication standard, in situations in which a network coverage in accordance with at least the second communication standard is not available, is presented. The wireless first- and second-type interfaces and/or the first and second communication standards are mutually non-interoperable and use an at least partly shared radio resource. The partly shared radio resource extends over a number of consecutive subcarriers and over time. Transmission frames in accordance with the first and second communication standards each comprise one or more subframes or slots, and the length or duration of slots of the first communication standard is a multiple of that of the slots of the second communication standard, preferably an integer multiple. The second-type interface of the third-type apparatus is configured to operate with a subcarrier spacing (SCS) that is a multiple of an SCS of the first-type interface of the third-type apparatus, preferably an integer multiple. The first-type wireless interface and the second-type wireless interface are communicatively coupled under control of one or more microprocessors of the third-type apparatus. The method comprises a step of determining a time offset between the start of a transmission and/or the beginning of a transmission frame in accordance with the first communication standard in a first subframe and the start of a transmission and/or a transmission frame in accordance with the second communication standard in said first subframe of a shared RP of the at least partly shared resource. The determined offset is then categorised into one of at least two offset categories, and the second-type interface of the third-type apparatus is operated in accordance with the offset category. The method further comprises transmitting the offset category via the second-type interface to second-type apparatus within radio range. Note that operating the second-type interface of the third-type apparatus in accordance with the offset category and transmitting the offset category via the second-type interface to second-type apparatus within radio range may occur in any sequence or more less simultaneously.

In accordance with one or more embodiments of the method in accordance with the first aspect of the invention further comprises transmitting, from a first control module of the first-type wireless interface of the third-type apparatus, a timing and format of a resource allocation within the shared resource for transmissions in accordance with the first standard to a second control module of the second-type wireless interface of the third-type apparatus. The first and second control modules, respectively, of the first- and second-type wireless interfaces may be implemented in software and/or hardware. The timing and format of a resource allocation may be previously received via the first-type wireless interface and may be transmitted to the control module of the second-type wireless interface prior to determining the time offset.

In accordance with one or more embodiments of the method in accordance with the first aspect of the invention the step of determining the time offset comprises determining the time offset between respective first slots of the transmissions in accordance with the two mutually non-interoperable communication standards in said first subframe. This may be preceded by the third-type apparatus requesting or obtaining an absolute timing from the first-type interface, which may then be used as a reference for determining the offset of the communication via the second-type interface.

In accordance with one or more embodiments of the method in accordance with the first aspect of the invention categorising the offset comprises determining numbers or positions of slots of transmissions transmitted in accordance with the second communication standard that fully lie inside of slots of transmissions transmitted in accordance with the first communication standard, or determining numbers or positions of slots of transmissions transmitted in accordance with the second communication standard that extend across neighbouring slots of transmissions transmitted in accordance with the first communication standard. Fully lying inside may also be interpreted as fully overlapping in time, and extending across neighbouring slots may be interpreted as partly overlapping both neighbouring slots in time.

In accordance with one or more embodiments of the method in accordance with the first aspect of the invention operating the second-type interface of the third-type apparatus in accordance with the offset category comprises transmitting data only in slots whose duration does not extend beyond a border between two neighbouring subframes of the shared resource pool of the at least partly shared resource and/or beyond a border between two neighbouring slots of transmissions in accordance with the first communication standard.

Examples for the operation of the second-type interface of the third-type apparatus in accordance with the offset category are shown in FIG. 10. Here, the first communication standard is LTE, and the second communication standard is 5G NR. One LTE slot extends over an entire subframe of an RP of the at least partly shared resource, which has a duration of 1 ms. One 5G NR slot has a duration of 0.5 ms, i.e., two consecutive 5G NR slots have the same duration as one LTE slot. Consecutive slots in a subframe are numbered in ascending order, beginning with 0 (zero). As mentioned earlier, LTE will remain unaltered, and subsequent standards will have to implement provisions for co-operating. Per the exemplary scenario discussed further above, 5G NR network coverage is not available, and the timing of 5G NR wireless interfaces within a given area without network coverage, while synchronized amongst each other, will not necessarily be synchronized with the LTE wireless interfaces.

The figure shows two neighbouring subchannels of a resource pool shared between LTE and 5G NR, with the LTE subchannel carrier spacing (SCS) being 15 KHz, as defined in the LTE standard. 5G NR may use different SCS, and in this example it is assumed that the 5G NR SCS is 30 kHz, i.e., a 5G NR transmission may “leak into” a neighbouring LTE subchannel. This may be without consequences when the respective LTE-defined subframe of the shared resource pool is not used by an LTE transmission, but may severely disturb the communication in said shared resource pool if such LTE-defined subframe of the shared resource pool is used by an LTE transmission on a neighbouring subchannel.

Using the LTE timing in subchannel SC1 as reference, the 5G NR transmission in subchannel SC2 is delayed, or shifted, by a Δt₁ that is less than half of the duration of the LTE slot (or the subframe, for that matter). As a consequence, the first 5G NR slot 0 fully lies within the LTE slot 0, but the second 5G NR slot 1 lies across the border of the neighbouring LTE slots. Assuming that the format of the LTE resource reservation and allocation in the shared resource pool of the shared resource, i.e., information indicating which RBs in the shared RP are used and which are available, has been made available to all wireless apparatus having a 5G NR wireless interface, e.g., using the method presented in PCT/IB2023/057907, 5G NR slot 0 will not cause any problem during an unused first LTE slot 0. 5G NR slot 1 would not cause any problem either if the timings were full aligned and synchronised. However, due to the shift, 5G NR slot 1 will extend into the second LTE slot 0, which may cause interference or disturbances if an active LTE transmission is present in that subframe.

Again using the LTE timing in subchannel SC1 as reference, the 5G NR transmission in subchannel SC2′ is delayed, or shifted, by a Δt₂ that is more than half of the duration of the LTE slot. Note that it is assumed that subchannel SC2′ lies adjacent to subchannel SC1, i.e., replaces subchannel SC2 from the previous example. Here, both NR slots time-wise extend into or fully lie within the second LTE slot in the second subframe, and may cause interference or disturbances if an active LTE transmission is present in that subframe.

To alleviate the situation the method in accordance with the first aspect of the invention categorises the offset such that the second-type interface of the third-type apparatus only transmits when the neighbouring subchannel is not used for an LTE transmission and when the NR slot fully lies, time-wise, within the unused subframe.

In the first example, only the NR slots 0, i.e., the even-numbered slots, would be used for transmission in the subframe, and only if the neighbouring subchannel is unused, while the NR slots 1, i.e., the odd-numbered slots, are not used for transmission, if the neighbouring subchannel in the adjacent subframe is used.

In the second example, only the only the NR slots 1, i.e., the odd-numbered slots, would be used for transmission and, due to the shift, in the adjacent LTE subframe, and only if the neighbouring subchannel is unused in said adjacent subframe, while the NR slots 0, i.e., the even-numbered slots, are not used for transmission, if the neighbouring subchannel in the first subframe is used.

The shift or offset between the two mutually not interoperable communication systems that is determined in the third-type apparatus can be subject to change or fluctuation. Thus, in accordance with one or more embodiments of the method in accordance with the first aspect of the invention, execution of the method may be retriggered by an expiration of a timer and/or a change of a time reference in the third-type apparatus.

In accordance with a second aspect of the invention, a third-type wireless apparatus or communication device is presented. The wireless apparatus or communication device comprises at least one transmitting and/or receiving antenna and associated electronic radio frequency circuitry, providing at least one first-type communication interface and at least one second-type communication interface. The wireless apparatus or communication device further comprises one or more microprocessors and associated volatile and non-volatile memory. The aforementioned elements are communicatively connected via one or more signal or data connections or buses. The non-volatile memory stores computer program instructions which, when executed by the one or more microprocessors configure the wireless communication apparatus for executing one or more embodiments of the method in accordance with the first aspect of the invention described hereinbefore.

In accordance with a third aspect of the invention, a method of operating a second-type apparatus comprising a second-type wireless interface configured for communication in accordance with a second communication standard, in situations in which a network coverage in accordance with the second communication standard is not available, comprises receiving an offset category via the second-type interface, e.g., from a third-type apparatus in accordance with the second aspect of the invention. The second-type apparatus then operates in accordance with the received offset category.

In accordance with one or more embodiments of the method in accordance with the third aspect of the invention, operating the second-type interface of the second-type apparatus in accordance with the offset category comprises transmitting data only in slots whose duration does not extend beyond a border between two neighbouring subframes of the shared resource pool of the at least partly shared resource and/or beyond a border between two neighbouring slots of transmissions in accordance with the first communication standard.

While the offset category, or information indicating the magnitude of the offset, may generally be transmitted or received in a broadcast transmission, in accordance with one or more embodiments of the methods in accordance with the first or the third aspect of the invention the second communication standard comprises messages carrying sidelink control information (SCI) that are transmitted via a physical control channel, including via a physical sidelink control channel (PSCCH). Transmitting or receiving, respectively, an offset category, or information indicating the magnitude of the offset, via the second-type interface may comprise transmitting or receiving at least a portion of said offset information via a first-stage control information, including via a first-stage sidelink control information (SCI-1).

In NR radio the SCI may be transmitted in two phases or parts, SCI-1 and SCI-2. The SCI-1 is transmitted over the PSCCH and it is intended to be decoded by all UE, so all UE have access to information about other UEs' resource reservation. In accordance with an implementation of this embodiment to NR, a new specific format for the SCI-1 may be defined, in which one bit from the reserved field is used, e.g., for signalling whether odd-numbered or even-numbered slots can be used for transmission without disturbing any LTE transmission on a neighbouring subchannel. As up to four bits are configurable for extending the standard, this is conceptually possible and quite convenient.

In accordance with one or more embodiments of the methods in accordance with the first or the third aspect of the invention the first-stage control information comprises information specifying a second-stage control information, including a second-stage sidelink control information (SCI-2). The second-stage control information may be accessible or decodable after decoding the first-stage control information.

While in this embodiment decoding the SCI-1 is required, it may provide more flexibility, as the size of the SCI-2 message can be indicated and offers more options for addressing the offset, in particular addressing offsets in connection with higher numerologies of second-type communication standards. FIG. 11 shows a schematic diagram illustrating the transmission paths of information in NR radio. The logical sidelink traffic channel (STCH) and the logical sidelink control channel (SCCH) are mapped on the sidelink shared channel (SL-SCH) transport channel, which is mapped on the physical sidelink shared channel (PSSCH) and the physical sidelink control channel (PSCCH). SCI-1 from the two-stage SCI is mapped on the PSSCH, while SCI-2 is mapped on the PSCCH.

FIG. 12 shows a simplified relationship between SCI1 and SCI-2 within a PSSCH transmission.

In accordance with a fourth aspect of the invention, a wireless apparatus or communication device comprising at least one transmitting and/or receiving antenna and associated electronic radio frequency circuitry providing at least one second-type communication interface is presented. The wireless apparatus or communication device further comprises one or more microprocessors and associated volatile and non-volatile memory. The aforementioned elements are communicatively connected via one or more signal or data connections or buses. The non-volatile memory stores computer program instructions which, when executed by the one or more microprocessors configure the wireless communication apparatus for executing one or more embodiments of the method in accordance with the third aspect of the invention described hereinbefore.

The methods presented hereinbefore may also be considered methods of coordinating access of first- and second-type wireless apparatus, or corresponding first- and second wireless interfaces thereof to shared radio resources, parts or portions of which radio resources being at least partly and/or temporarily used shared between said first- and second-type wireless interfaces. The first-type and second-type wireless communication interfaces are not interoperable. The expression partly shared may be interpreted as relating to the simultaneous, respectively exclusive use of channels, sub-channels, time slots or resource elements of the radio resources for communications via wireless interfaces of the first and second type. The resource elements may comprise physical resource blocks, channels, sub-channels, or groups thereof, and may further comprise time slots, or any combination of any of the aforementioned elements. In conjunction with resource allocations for future transmissions made available to all wireless apparatus the methods permit enabling or disabling transmission of slots of a communication standard with a higher numerology for preventing interference with transmissions with a lower numerology in case of timing offsets between the two not interoperable communication standards.

The second-type wireless interfaces may be configured to directly receive resource allocation information for first-type wireless interfaces, and to extract relevant information in electronic circuitry associated with the second-type wireless interface. Otherwise, the resource allocation information is received by first-type wireless interfaces of third-type apparatus and is internally, i.e., within the third-type apparatus, transferred to electronic circuitry for generating corresponding information which is then transmitted to the second-type wireless interface of the third-type apparatus, and distributed further. If received in coded form, the received information may be decoded in electronic circuitry associated with the first-type wireless interface prior to being internally transferred.

Throughout this specification electronic circuitry associated with the first-type wireless interface in a third-type apparatus may have common elements with the electronic circuitry associated with the second-type wireless interface thereof, e.g., when the actual function of the electronic circuitry associated with the first-type or second-type wireless interface is implemented as computer program instructions, these may be executed by the same physical microprocessor or physical or logical core thereof, using the same physical volatile memory.

The electronic circuitry associated with the first-type wireless interface or with the second-type wireless interface, or both, may comprise, inter alia, one or more microprocessors, associated volatile and non-volatile memory, and may execute computer program instructions, stored in the non-volatile memory, that execute decoding, coding, inter-apparatus sharing of information, and/or control of physical elements of wireless interfaces or other elements of the apparatus it is provided in.

The methods according to the invention presented herein add robustness to and/or improve the co-existence of mutually incompatible wireless communication systems, e.g., in sidelink communication, through the use of dual-mode UEs configured for executing at least some of the methods. In addition to sharing information about unused resource elements in the shared resource, the dual mode UEs determine timing offsets between transmissions in accordance with the first and second communication standard and use and forward such information to UEs that are limited to communicating in accordance with the second communication standard, for accordingly modifying the operation of the second-type wireless interfaces. The methods presented herein are backward-compatible with existing resource reservation and allocation schemes of LTE and NR.

The various aspects, and developments and embodiments thereof, presented hereinbefore may individually or interconnectedly address one or more of the problems initially discussed.

The methods described hereinbefore may be represented by computer program instructions. Accordingly, a computer program product comprises computer program instructions which, when executed by a microprocessor of a wireless apparatus, communication device or network component cause the microprocessor to execute methods in accordance with one or more of the methods of the present invention presented herein, and to accordingly control hardware and/or software blocks or modules of the wireless apparatus, communication device or network component in accordance with the invention as likewise presented herein.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

While the invention has been discussed with a focus on 4G LTE and 5G NR as examples for mutually not interoperable standards it is obvious that the present invention can be used with great advantage in all communication scenarios in which communication in accordance with mutually non-interoperable standards occurs in the same or at least overlapping resources, e.g., frequency channels and time slots, when the mutually non-interoperable standards use different subchannel spacing. A particularly useful application of the invention is the side link communication in vehicle-to-X (V2X) communication scenarios in the ITS frequency spectrum.

### BRIEF DESCRIPTION OF THE DRAWING

An aspect of the invention will now be described with reference to the drawing, in which

FIG. 1 schematically illustrates the channelization in LTE V2X mode 4 sensing-based SPS scheduling with an exemplary length T=100 ms,

FIG. 2 schematically illustrates the concept of resource pools,

FIGS. 3A-3B show examples of overlapping resource pools in a channel used by two otherwise not-interoperable radio access technologies,

FIG. 4 depicts an exemplary LTE resource pool structure showing, inter alia, reserved or allocated resource elements and available resource elements for an adjacent resource assignment and a nonadjacent resource assignment in the physical SL control channel (PSCCH) and the physical SL shared channel (PSSCH),

FIG. 5 shows a schematic example for overlapping resource pools in a frequency channel used for co-channel co-existence, where an overlapping part or portion is used shared,

FIG. 6 shows first exemplary arrangements of RP slots of an LTE subframe having an SCS of 15 KHz and of RP slots of NR subframes NR having an SCS of 30 kHz,

FIG. 7 shows second exemplary arrangements of RP slots of an LTE subframe having an SCS of 15 kHz and of RP slots of NR subframes NR having an SCS of 30 KHz,

FIGS. 8A and 8B show exemplary representations of situations addressed by the present invention in the presence of at least one radio access network,

FIG. 9 shows an exemplary representation of a situation addressed by the present invention when no radio access network is present,

FIG. 10 shows examples for the operation of the second-type interface of the third-type apparatus in accordance with the offset category,

FIG. 11 shows a schematic diagram illustrating the transmission paths of information in NR radio,

FIG. 12 shows a simplified relationship between SCI1 and SCI-2 within a PSSCH transmission,

FIG. 13 shows an exemplary schematic block diagram of a third-type wireless apparatus or communication device in accordance with the present invention,

FIG. 14 shows an exemplary schematic block diagram of a second-type wireless apparatus in accordance with the present invention, and

FIG. 15 shows the main steps of the methods in accordance with the first and the third aspects of the invention in relation to each other, further showing message exchanges between them.

In the figures identical or similar elements may be referenced using the same reference designators.

### DETAILED DESCRIPTION OF EXEMPLARY EMBODIMENTS

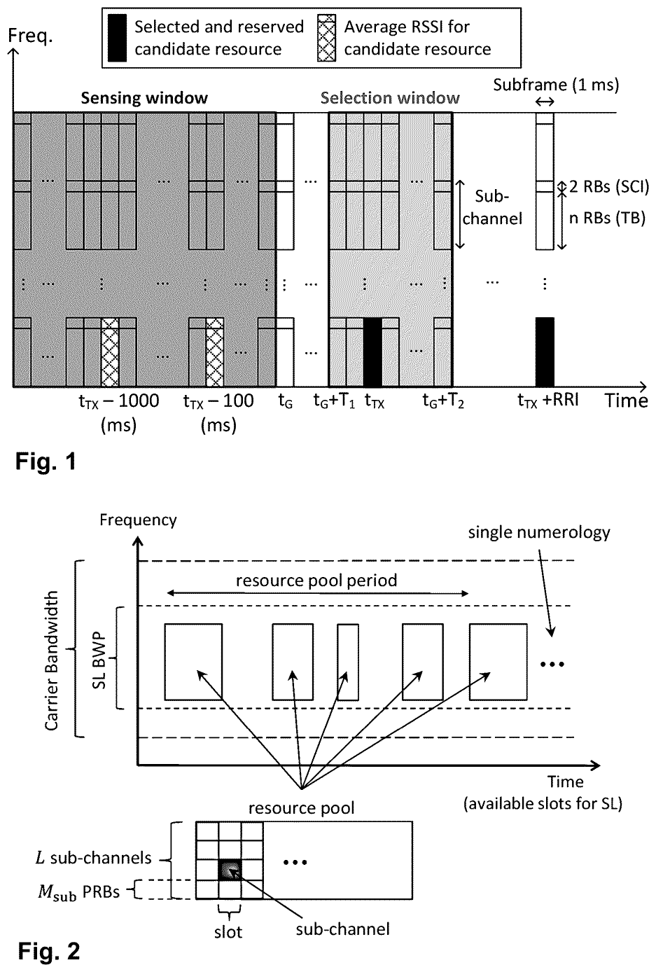

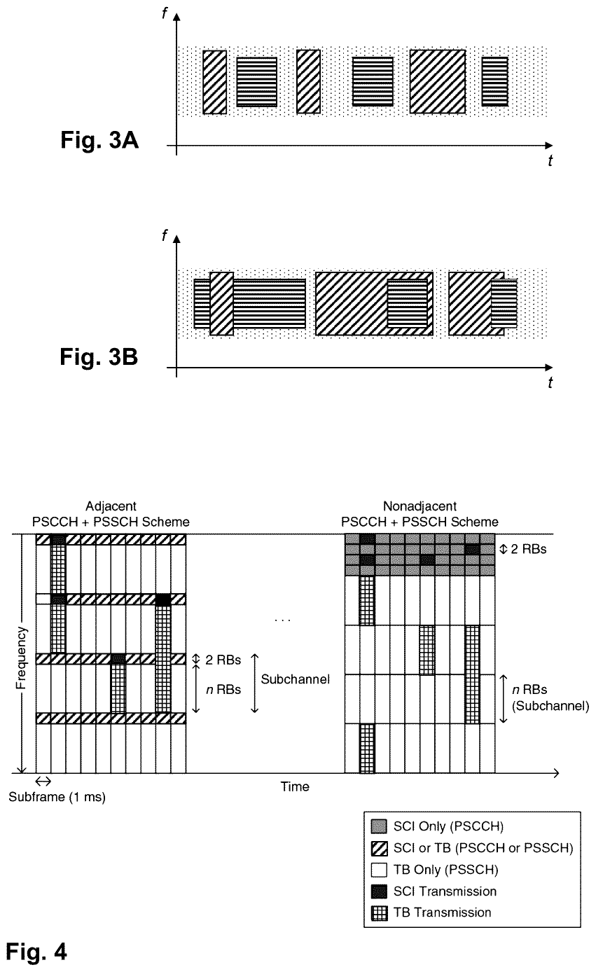

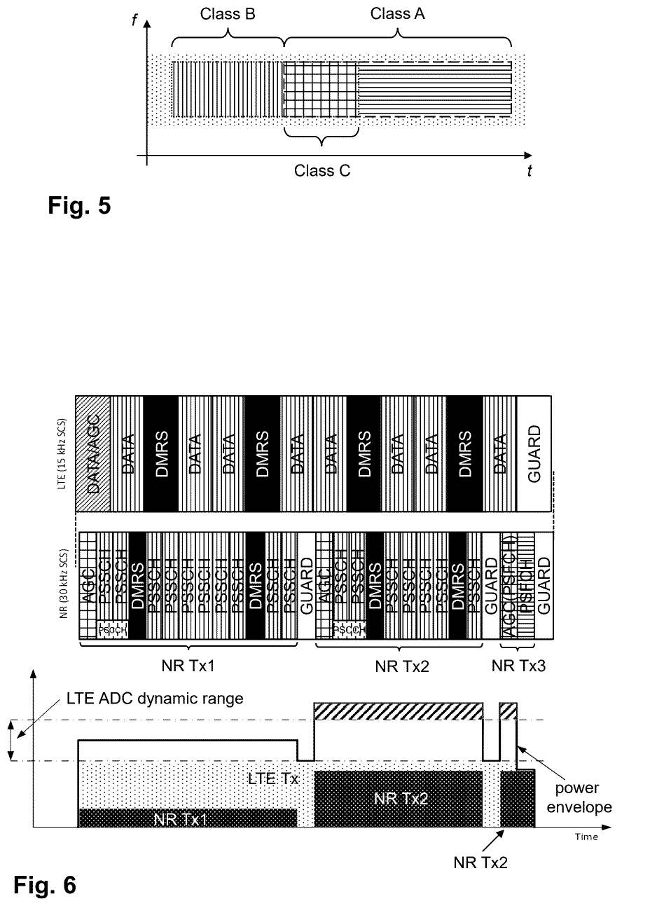

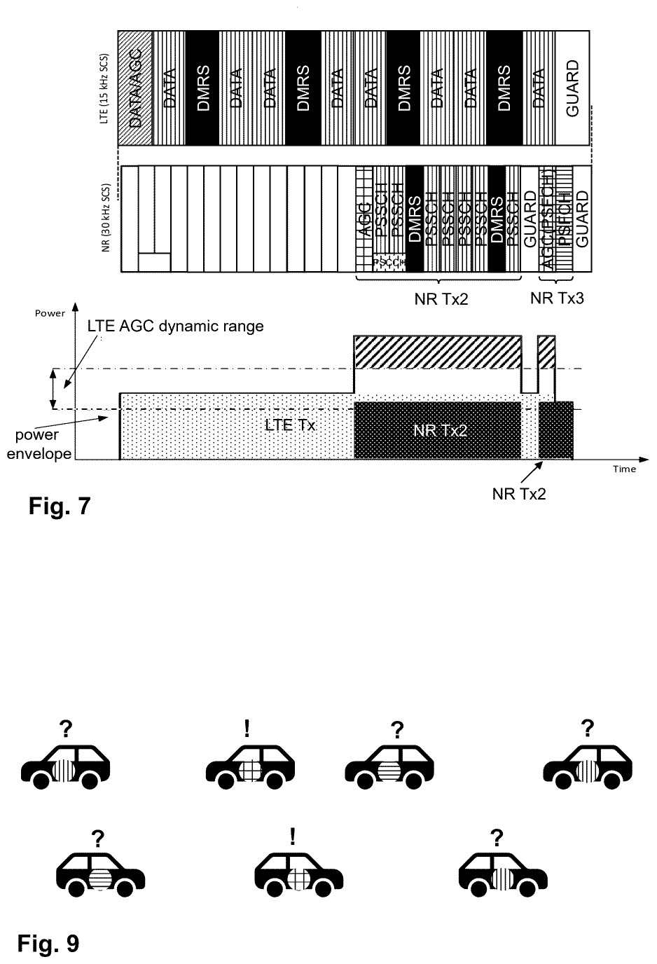

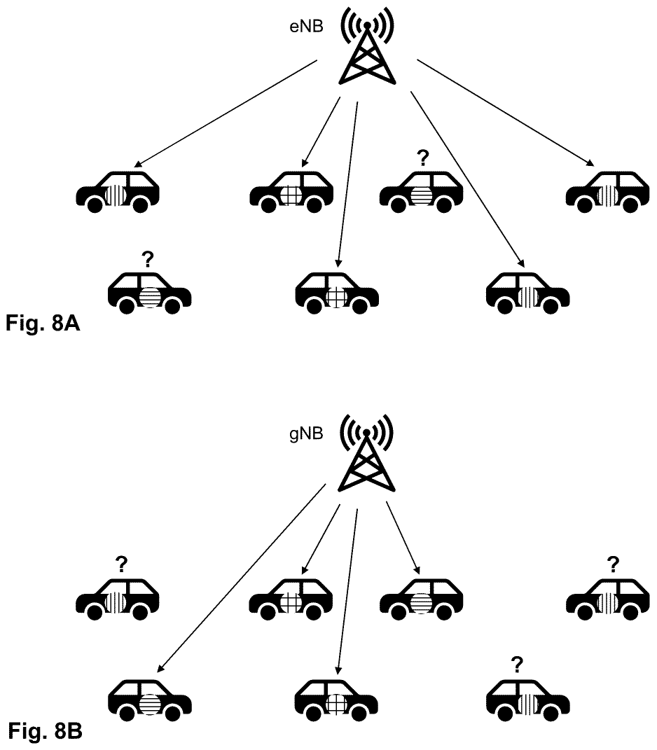

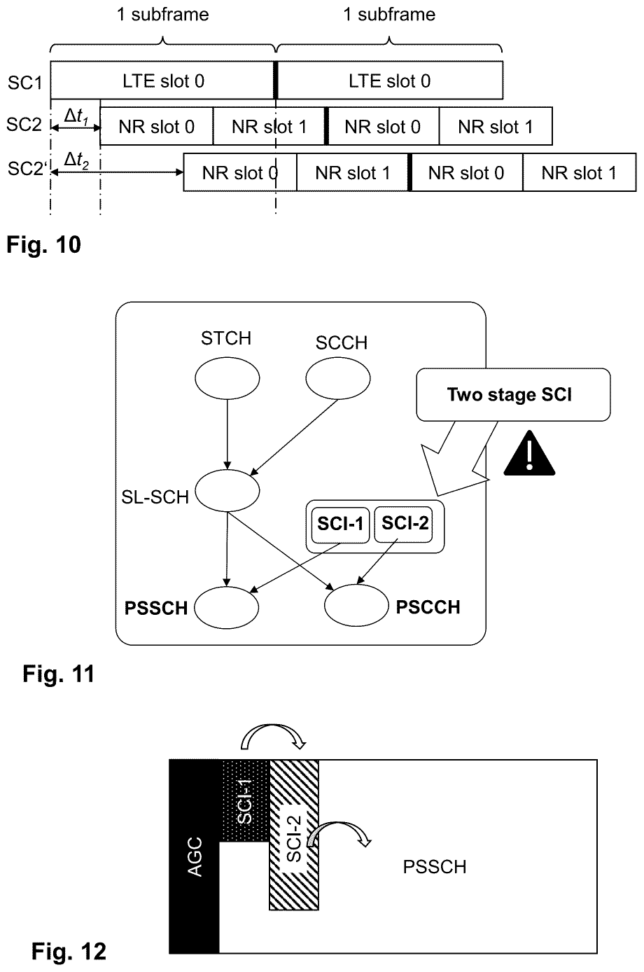

FIGS. 1 to 12 have already been discussed further above and will not be addressed again.

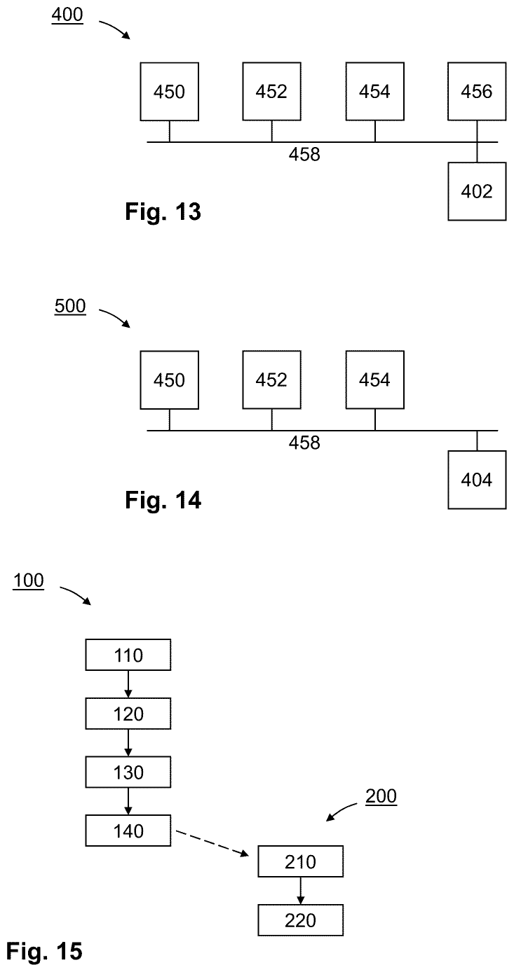

FIG. 13 shows an exemplary schematic block diagram of a third-type wireless apparatus or communication device 400 in accordance with the second aspect of the present invention. The wireless apparatus or communication device 400 comprises one or more antennas 402 and associated wireless interface circuitry 456, providing at least one first-type communication interface and one second-type communication interface, for communicating with one or more further wireless apparatus or communication devices or a network component 500 (not shown in the figure), one or more microprocessors 450, volatile memory 452 and non-volatile memory 454. The aforementioned elements are communicatively connected via one or more signal or data connections or buses 458. The non-volatile memory 454 stores computer program instructions which, when executed by the microprocessor 450, cause the wireless apparatus or communication device 400 to execute the method according to first aspect of the invention as presented hereinbefore.

FIG. 14 shows an exemplary schematic block diagram of a second-type wireless apparatus 500 in accordance with the fourth aspect of the present invention. The second-type wireless apparatus 500 comprises one or more microprocessors 450, volatile memory 452, non-volatile memory 454, and a second-type wireless interface 404 for communicating with one or more further second-type wireless apparatus and/or with one or more third-type wireless apparatus or communication devices 400 in accordance with the second aspect of the present invention (not shown in the figure). The aforementioned elements are communicatively connected via one or more signal or data connections or buses 458. The non-volatile memory 454 stores computer program instructions which, when executed by the microprocessor 450, cause the network component 500 to execute the method according to the third aspect of the invention as presented hereinbefore.

FIG. 15 shows the main steps of the methods 100 and 200 in accordance with the first and the third aspects of the invention, respectively, in relation to each other, further showing message exchanges between them. In step 110 the third-type apparatus determines a time offset between the start of a transmission in accordance with the first communication standard in a first subframe and the start of a transmission in accordance with the second communication standard in said first subframe of a shared resource pool of the at least partly shared resource. In step 120 the third-type apparatus categorises the offset into one of at least two offset categories. In step 130 the third-type apparatus operates its second-type interface in accordance with the offset category, and in step 140 the third-type apparatus transmits the offset category to other apparatus having a second-type interface within wireless range. In step 210 such other apparatus having a second-type interface receive the offset category, and operate, in step 220, their second-type interfaces in accordance with the received offset category.

LIST OF REFERENCE NUMERALS
(PART OF THE DESCRIPTION)

| | |
|---|---|
| 100 | method |
| 110 | determining |
| 120 | categorising |
| 130 | operating |
| 140 | transmitting |
| 200 | method |
| 210 | receiving |
| 220 | operating |
| 400 | apparatus/communication device |
| 402 | antenna |
| 450 | microprocessor |
| 452 | volatile memory |
| 454 | non-volatile memory |
| 456 | wireless interface circuitry |
| 458 | signal/data connection/bus |
| 500 | apparatus/communication device |

1. A method of operating a third-type apparatus comprising a first-type wireless interface configured for communication in accordance with a first communication standard and a second-type wireless interface configured for communication in accordance with a second communication standard, in situations in which a network coverage in accordance with at least the second communication standard is not available, wherein the wireless first- and second-type interfaces and/or communication standards are mutually non-interoperable and use an at least partly shared radio resource, wherein transmission frames in accordance with the first and second communication standards each comprise one or more subframes or slots, and wherein the length or duration of slots of the first communication standard is a multiple of that of the slots of the second communication standard, wherein the second-type interface of the third-type apparatus is configured to operate with a subcarrier spacing that is an integer multiple of an SCS of the first-type interface of the third-type apparatus, and wherein the first-type wireless interface and the second-type wireless interface are communicatively coupled under control of one or more microprocessors of the third-type apparatus, the method comprising:
determining a time offset between the start of a transmission and/or a transmission frame in accordance with the first communication standard in a first subframe and the start of a transmission and/or a transmission frame in accordance with the second communication standard in said first subframe of a shared resource pool of the at least partly shared resource,
categorising the offset into one of at least two offset categories,
operating the second-type interface of the third-type apparatus in accordance with the offset category, and
transmitting the offset category via the second-type interface to second-type apparatus within radio range.

2. The method of claim 1, further comprising transmitting, from a first control module of the first-type wireless interface of the third-type apparatus, a timing and format of a resource allocation within the shared resource for transmissions in accordance with the first standard to a second control module of the second-type wireless interface of the third-type apparatus.

3. The method of claim 1, wherein determining the time offset comprises determining the time offset between respective first slots of the transmissions in accordance with the two mutually non-interoperable communication standards in said first subframe.

4. The method of claim 1, wherein categorising the offset comprises determining numbers or positions of slots of transmissions transmitted in accordance with the second communication standard that fully lie inside of slots of transmissions transmitted in accordance with the first communication standard, or determining numbers or positions of slots of transmissions transmitted in accordance with the second communication standard that extend across neighbouring slots of transmissions transmitted in accordance with the first communication standard.

5. The method of claim 1, wherein operating the second-type interface of the third-type apparatus in accordance with the offset category comprises:
transmitting data only in slots whose duration does not extend beyond a border between two neighbouring subframes of the shared resource pool of the at least partly shared resource.

6. The method of claim 1, wherein execution of the method is triggered by an expiration of a timer and/or a change of a time reference in the third-type apparatus.

7. A wireless apparatus or communication device comprising at least one transmitting and/or receiving antenna and associated electronic radio frequency circuitry, providing at least one first-type communication interface and one second-type communication interface, further comprising one or more microprocessors and associated volatile and non-volatile memory, wherein the aforementioned elements are communicatively connected via one or more signal or data connections or buses, wherein the non-volatile memory stores computer program instructions which, when executed by the one or more microprocessors configure the wireless communication apparatus for performing a method of claim 1.

8. A method of operating a second-type apparatus comprising a second-type wireless interface configured for communication in accordance with a second communication standard, in situations in which a network coverage in accordance with the second communication standard is not available, the method comprising:
receiving an offset category via the second-type interface, and
operating the second-type interface of the second-type apparatus in accordance with the received offset category.

9. The method of claim 8, wherein operating the second-type interface of the second-type apparatus in accordance with the offset category comprises:
transmitting data only in slots whose duration does not extend beyond a border between two neighbouring subframes of transmissions in accordance with the first communication standard.

10. The method of claim 1, wherein the second communication standard comprises messages carrying sidelink control information that are transmitted via a physical control channel, including via a physical sidelink control channel, and wherein transmitting or receiving, respectively, an offset category, or information indicating the magnitude of the offset, via the second-type interface comprises transmitting or receiving at least a portion of said offset information via a first-stage control information, including via a first-stage sidelink control information.

11. The method of claim 10, wherein the first-stage control information comprises information specifying a second-stage control information, including a second-stage sidelink control information, and wherein the second-stage control information is accessible or decodable after decoding the first-stage control information.

12. A wireless apparatus or communication device comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, wherein the non-volatile memory stores computer program instructions which, when executed by the one or more microprocessors configure the wireless communication apparatus for performing a method of claim 8.

13. A non-transitory computer program product comprising instructions which, when the instructions are executed by a microprocessor, cause a computer and/or control hardware blocks, modules or components of an apparatus or communication device comprising at least one transmitting and/or receiving antenna and associated electronic radio frequency circuitry, providing at least one first-type communication interface and one second-type communication interface, further comprising one or more microprocessors and associated volatile and non-volatile memory, wherein the aforementioned elements are communicatively connected via one or more signal or data connections or buses to carry out a method of claim 1.

14. A non-transitory computer readable medium or data carrier retrievably transmitting or storing the computer program product of claim 13.

15. The method of claim 8, wherein the second communication standard comprises messages carrying sidelink control information that are transmitted via a physical control channel, including via a physical sidelink control channel, and wherein transmitting or receiving, respectively, an offset category, or information indicating the magnitude of the offset, via the second-type interface comprises transmitting or receiving at least a portion of said offset information via a first-stage control information, including via a first-stage sidelink control information.

16. A non-transitory computer program product comprising instructions which, when the instructions are executed by a microprocessor, cause a computer and/or control hardware blocks, modules or components of an apparatus or communication device comprising at least one transmitting and/or receiving antenna and associated electronic radio frequency circuitry, providing at least one first-type communication interface and one second-type communication interface, further comprising one or more microprocessors and associated volatile and non-volatile memory, wherein the aforementioned elements are communicatively connected via one or more signal or data connections or buses to carry out a method of claim 8.
